(19) United States
(12) Patent Application Publication
(10) Pub. No.: US 2009/0075042 A1
(43) Pub. Date: Mar. 19, 2009

(54) HAND-TEARABLE NON-ELASTIC TAPE

(75) Inventor: Thomas S. MURPHY, Boxford, MA (US)

Correspondence Address: WILMERHALE/BOSTON, 60 STATE STREET, BOSTON, MA, 02109, US

(73) Assignee: ANDOVER HEALTHCARE, INC., Salisbury, MA (US)

(21) Appl. No.: 11/947,933

(22) Filed: Nov. 30, 2007

Related U.S. Application Data
(63) Continuation of application No. 10/946,221, filed on Sep. 21, 2004, now abandoned.

(51) Int. Cl. C09J 7/04; B32B 5/26; D04B 1/22; B32B 7/02

(52) U.S. Cl. 428/212; 442/247; 442/318; 442/35; 442/32; 442/312

(57) ABSTRACT

A laminated non-elastic tape is provided. The laminated tape may include two layers of material, each layer having warp yarns extending longitudinally of the tape and weft yarns extending transversely of the tape. The warp yarns may be non-elastic. The two layers of material having warp yarns and weft yarns may be, for example, warp-knitted weft-insertion fabrics, scrim woven fabrics, or any other suitable material that facilitates hand-tearing of the tape. The tape may include a layer of nonwoven material positioned, for example, between the two layers of material. The layers of material may be bonded together with a binder. In some embodiments, the binder may be a latex- or non-latex-based cohesive agent.

### CROSS-REFERENCE TO RELATED APPLICATIONS

This application is a continuation of U.S. application Ser. No. 10/946221, filed on Sep. 21, 2004, the entire contents of which are hereby incorporated by reference herein.

### BACKGROUND OF THE INVENTION

The present invention relates to a hand-tearable non-elastic tape and, more particularly, to a hand-tearable non-elastic tape that includes a non-elastic layer of material to facilitate hand tearing of the tape and a nonwoven layer of material laminated thereto.

Tapes and bandages are widely used in athletic applications to promote the protection and safety of athletes. In such applications, for example, the tensile strength of the tape or bandage is often an important factor in providing adequate protection for the athlete. However, because such tapes are often elastic in nature, the tapes may not possess the desired tensile strength. Furthermore, such tapes also often utilize adhesive formulations that stick to hair and skin and thereby complicate removal. Still further, many of the tapes and bandages that do possess the requisite tensile strength for sports medicine applications are inconvenient to apply because they must be cut to size using a blade. Or, if the tape can be torn by hand, the increased strength often makes doing so difficult and can result in an unclean tear in the longitudinal and transverse directions.

Accordingly, it would be desirable to provide a tape that is both hand-tearable and non-elastic including a non-elastic layer of material to facilitate hand tearing of the tape and a nonwoven layer of material laminated thereto. Furthermore, it would also be desirable to provide such a hand-tearable and non-elastic tape that utilizes a cohesive formulation, rather than an adhesive formulation, so that the tape sticks securely to itself but can be easily removed without sticking to skin or hair. Such a non-elastic, hand-tearable tape would be useful in multiple applications, including sports medicine, athletic training and orthopedic medicine.

### BRIEF SUMMARY OF THE INVENTION

In accordance with the present invention, a hand-tearable non-elastic tape is provided that includes a non-elastic layer of material to facilitate hand tearing of the tape and a nonwoven layer of material laminated thereto. The non-elastic, hand-tearable tapes of the invention are characterized by having less than 10% longitudinal stretch, generally not more than about 4% longitudinal stretch, and, most usefully, not more than about 1% longitudinal stretch (e.g., 0.5% longitudinal stretch or less). Furthermore the non-elastic, hand-tearable tapes of the invention are characterized by a lack of elastomeric material in the tape fabrics (although cohesive agents that are optionally used as a binder and/or to coat the tapes of the invention, may include an elastomer compound as described further below). While many possible types and combinations of non-elastic and nonwoven materials are possible as described in further detail below, the skilled artisan will appreciate the hand-tearable character of the various resulting non-elastic tapes included within the scope of the invention.

In one aspect the invention provides a laminated non-elastic tape that includes two layers of material, each layer having warp yarns extending longitudinally of the tape and weft yarns extending transversely of the tape. The warp yarns may be non-elastic. The tape may include a layer of nonwoven material positioned between the two layers of material. In certain embodiments, one or both of the two layers of material that include warp yarns and weft yarns may be a warp-knitted weft-insertion fabric. The warp yarns of the layer or layers of warp-knitted weft-insertion fabric may include, for example, a plurality of longitudinally-spaced knitted loops through which the weft yarns extend transversely of the tape. In certain embodiments, one or both of the two layers of material that include warp yarns and weft yarns may be a scrim woven fabric. Adjacent warp yarns of the layer or layers of scrim woven fabric may extend longitudinally of the tape on opposing sides of a plane defined by the weft yarns. In certain embodiments, one of the two layers of material that include warp yarns and weft yarns may be a warp-knitted weft-insertion fabric, and the other of the two layers of material that includes warp yarns and weft yarns may be a scrim woven fabric.

In certain embodiments, one or both of the warp yarns and weft yarns may be yarns of polyolefin, polyester, polycotton, cotton or any other suitable material. In certain embodiments, the weft yarns of one or both of the layers of material that include warp yarns and weft yarns may be texturized filament yarns.

In certain embodiments, at least one of the two layers of material that include warp yarns and weft yarns may have warp yarns spaced at a density in the range of 12 to 24 yarns per inch measured transversely of the tape. In one example, the warp yarns may be spaced at a density of about 18 yarns per inch measured transversely of the tape. In certain embodiments, at least one of the two layers of material that include warp yarns and weft yarns may have warp yarns with a denier in the range of 30 to 80. In one example, the warp yarns may have a denier of about 50. In another example, the warp yarns may have a denier of about 40.

In certain embodiments, at least one of the two layers of material that include warp yarns and weft yarns may have weft yarns spaced at a density in the range of 9 to 18 yarns per inch measured longitudinally of the tape. In one example, the weft yarns may be spaced at a density of about 12 yarns per inch measured longitudinally of the tape. In certain embodiments, at least one of the two layers of material that include warp yarns and weft yarns may have weft yarns with a denier in the range of 50 to 200. In one example, the weft yarns may have a denier of about 150. In another example, the weft yarns may have a denier of about 70.

In certain embodiments, each layer of the two layers of material that include warp yarns and weft yarns may have a weight of not more than about 1.5 ounces per square yard. In one example, each layer may have a weight in the range of 0.3 to 0.8 ounces per square yard. In another embodiment, each layer may have a weight in the range of 0.3 to 0.5 ounces per square yard.

In certain embodiments, the warp yarns of at least one of the two layers of material may include a plurality of longitudinally-spaced knitted loops that each include three yarn portions. The weft yarns of the layer or layers of material may extend transversely of the tape through the loops of the warp yarns.

In certain embodiments, the laminated tape may include a binder bonding the layers together. The binder may be, for example, a cohesive or adhesive agent. In embodiments in which the binder is a cohesive agent, the binder may be a latex-based cohesive agent such as a natural rubber latex-based cohesive agent. Alternatively, in embodiments in which the binder is a cohesive agent, the binder may be a synthetic water-based cohesive agent. The synthetic water-based cohesive agent may include, for example, an elastomer having an inherently crystalline structure (e.g., polychloroprene, polyester polyurethane, polycaprolactone polyurethane, etc.). The water-based agent may include at least one tackifying agent in an amount effective to disrupt the crystalline structure of the elastomer in a partial polycrystalline state such that the elastomer possesses a cohesive property. In certain embodiments, the binder may impregnate each of the layers of the laminated tape.

In certain embodiments, the laminated tape may include a cohesive agent. In one example, the cohesive agent may be a latex-based cohesive agent. In another example, the cohesive agent may be a synthetic water-based cohesive agent.

In certain embodiments, the nonwoven material of the laminated tape may be a synthetic spunbonded nonwoven material. The nonwoven material may have a weight of no more than about 1.0 ounce per square yard. In one example, the nonwoven material may have a weight in the range of 0.3 to 0.5 ounces per square yard. In certain embodiments, the nonwoven material may be a synthetic spunbonded nonwoven material such as, for example, nylon, polyester, polypropylene, rayon, or any other suitable material, and may have a weight of not more than about 0.3 ounces per square yard.

In certain embodiments, the laminated layers of material may yield a longitudinal tensile strength in the range of 30 to 60 pounds per inch. In one example, the laminated layers of material may yield a longitudinal tensile strength of about 40 pounds per inch. In such an example, the two layers of material that include warp yarns and weft yarns may each have a longitudinal tensile strength of about 20 pounds per inch. Alternatively, one of the two layers of material that include warp yarns and weft yarns may have a longitudinal tensile strength of about 18 pounds per inch, and the other of the two layers of material that include warp yarns and weft yarns may have a longitudinal tensile strength of about 22 pounds per inch.

In certain embodiments, the two layers of material that include warp yarns and weft yarns may facilitate transverse and longitudinal hand tearing of the tape.

In certain embodiments, the laminated tape may include a pressure-sensitive adhesive coated on the outer side of one of the two layers of material that include warp yarns and weft yarns.

In another aspect of the invention, a laminated non-elastic tape may be provided that includes a first layer of material having warp yarns extending longitudinally of the tape and weft yarns extending transversely of the tape. The warp yarns may be non-elastic. The tape may include a second layer of nonwoven material positioned adjacent to the first layer. In certain embodiments, the laminated tape may include a third layer of material having non-elastic warp yarns extending longitudinally of the tape and weft yarns extending transversely of the tape. In one example, the second layer of material may be positioned between the first and third layers of material. In another example, the first layer of material may be positioned between the second and third layers of material.

In a further aspect of the present invention, a laminated non-elastic tape may be provided that includes first and second layers of warp-knitted weft-insertion material to facilitate transverse and longitudinal hand tearing of the tape. The first and second layers of warp-knitted weft-insertion material may include polyester non-elastic warp yarns extending longitudinally of the tape and texturized polyester filament weft yarns extending transversely of the tape. The warp yarns may include a plurality of longitudinally-spaced knitted loops through which the weft yarns extend. The warp yarns may be spaced at a density of about 18 yarns per inch measured transversely of the tape, and the weft yarns may be spaced at a density of about 12 yarns per inch measured longitudinally of the tape. The first layer of warp-knitted weft-insertion material may have a weight of about 0.7 ounces per square yard. The warp yarns of the first layer may have a denier of about 50, and the weft yarns of the first layer may have a denier of about 150. The second layer of warp-knitted weft-insertion material may have a weight of about 0.4 ounces per square yard. The warp yarns of the second layer may have a denier of about 40, and the weft yarns of the second layer may have a denier of about 70. A layer of polypropylene spunbonded nonwoven material may be positioned between the first and second layers of warp-knitted weft-insertion material. The layer of spunbonded nonwoven material may be composed of, in addition to polypropylene, any other suitable fiber, such as, for example, nylon. The nonwoven material may have a weight in the range of 0.3 to 0.5 ounces per square yard. The tape may include a binder that impregnates each of the layers to bond the layers together. The binder may be a natural rubber latex-based cohesive agent. The first layer of the warp-knitted weft-insertion material may have a longitudinal tensile strength of about 22 pounds per inch, and the second layer of warp-knitted weft-insertion material may have a longitudinal tensile strength of about 18 pounds per inch. This combination of tensile strengths may yield a longitudinal tensile strength of about 40 pounds per inch for the laminated layers of warp-knitted weft-insertion material and nonwoven material.

### BRIEF DESCRIPTION OF THE DRAWINGS

FIG. 1 is a top view of an illustrative hand-tearable non-elastic tape in accordance with the present invention.

FIG. 2 is a top view, partially broken away, of the tape of FIG. 1.

FIG. 3 is an enlarged sectional view of the tape of FIG. 1.

FIG. 4 is an enlarged sectional view of another illustrative hand-tearable non-elastic tape in accordance with the present invention.

FIGS. 5 and 6 are microscopic photographs of an illustrative warp-knitted weft-insertion fabric that may be used as a layer of the illustrative tapes shown in FIGS. 1 and 4 in accordance with the present invention.

FIG. 7 is an enlarged top view of an illustrative scrim woven fabric that may be used as a layer of the illustrative tapes shown in FIGS. 1 and 4 in accordance with the present invention.

### DETAILED DESCRIPTION OF THE INVENTION

In accordance with the present invention, a hand-tearable non-elastic tape is provided that includes a non-elastic layer of material to facilitate hand tearing of the tape and a nonwoven layer of material laminated thereto.

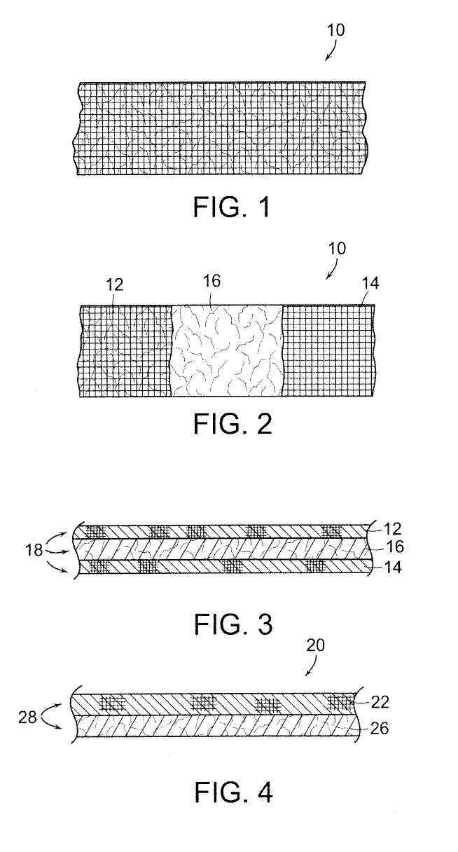

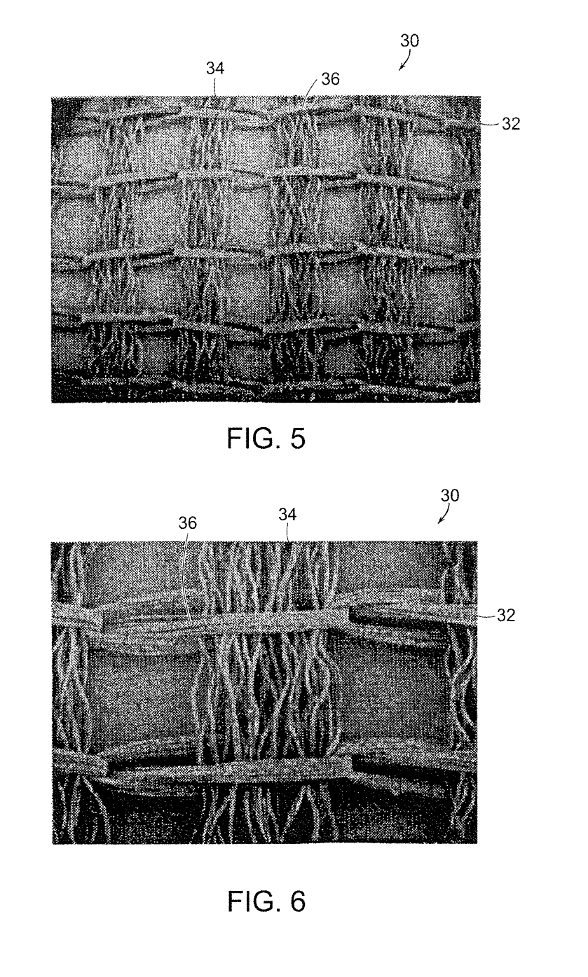

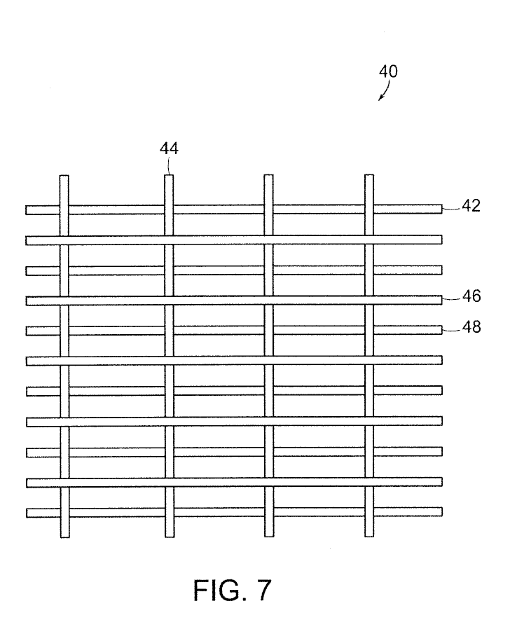

FIG. 1 shows a top view of an illustrative hand-tearable non-elastic tape 10 in accordance with the present invention, FIG. 2 shows a top view of tape 10 partially broken away to illustrate the various layers included in the tape, and FIG. 3 shows a sectional view of tape 10 to demonstrate the interaction between the various layers of the tape. Tape 10 may include layers 12 and 14 to facilitate hand-tearing of the tape. In particular, layers 12 and 14 may include warp yarns extending longitudinally of the tape and weft yarns extending transversely of the tape (see, for example, FIGS. 5 and 6, which illustrate a warp-knitted weft-insertion fabric, and FIG. 7, which illustrates a scrim woven fabric). The inclusion of such warp yarns and weft yarns facilitates hand-tearing tape 10 in both the longitudinal and transverse directions. At least the warp yarns of layers 12 and 14 are non-elastic so that tape 10 is non-elastic in the longitudinal direction. Tape 10 may include a layer 16 of nonwoven material positioned between layers 12 and 14. (It should be noted that the order of layers 12, 14, and 16 shown in FIGS. 1-3 is merely illustrative. For example, layers 12 and 14 may be positioned adjacent to one another, with layer 16 forming an outer surface of tape 10.) Layers 12, 14, and 16 may be bonded together using a binder 18 (binder 18 will be described in more detail hereinbelow).

As described hereinabove, layers 12 and 14 may be materials that facilitate hand- tearing of tape 10. Layers 12 and 14 may be materials that provide tape 10 with suitable longitudinal tensile strength for use in applications such as, for example, wrapping an athlete's ankle, hand, wrist, thumb, shoulder, or any other suitable application. Thus, layers 12 and 14 may be any suitable material that provides suitable hand-tearability and longitudinal tensile strength to tape 10.

In some embodiments of the present invention, one or both of layers 12 and 14 may be a warp-knitted weft-insertion fabric. In particular, in a warp-knitted weft-insertion fabric, the warp yarns may include a plurality of longitudinally-spaced knitted loops through which the weft yarns extend transversely of the tape. Microscopic photographs demonstrating this construction are shown in FIGS. 5 and 6. (FIG. 5 is taken at 11.5× magnification, and FIG. 6 is taken at 30× magnification.) FIGS. 5 and 6 show an illustrative warp-knitted weft-insertion fabric 30 that includes warp yarns 32 extending longitudinally and weft yarns 34 extending transversely. Warp yarns 32 of illustrative fabric 30 include loops 36 through which weft yarns 34 extend. In some embodiments of the present invention, and as shown in FIGS. 5 and 6, warp yarns 32 may be knitted such that loops 36 include three yarn portions. However, this example is merely illustrative, and loops 36 may include any suitable number of yarn portions.

In some embodiments of the present invention, one or both of layers 12 and 14 may be a scrim woven fabric. FIG. 7 shows an illustrative scrim woven fabric 40 in accordance with the present invention. Scrim woven fabric 40 includes warp yarns 42 and weft yarns 44. Adjacent warp yarns 42 extend longitudinally on opposing sides of the plane defined by weft yarns 44 (see, for example, adjacent warp yarns 46 and 48).

Referring back to FIGS. 1-3, the warp yarns and weft yarns of layers 12 and 14 may be yarns of any suitable material. For example, the warp yarns and weft yarns may be yarns of polyolefin, polyester, polycotton, cotton, or any other suitable material that allows for hand-tearing of tape 10 and provides the desired tensile strength. The weft yarns extending transversely of the tape may be, for example, texturized filament yarns.

The warp yarns of layers 12 and 14 may be spaced at a density in the range of 9 to 48 yarns per inch as measured transversely of tape 10. In some embodiments, the warp yarns may be spaced at a density in the range of 12 to 24 yarns per inch as measured transversely tape 10. Alternatively, the warp yarns may be spaced at a density in the range of 18 to 30 yarns per inch, 30 to 48 yarns per inch, or any other suitable range of densities. The warp yarns of layers 12 and 14 may have a denier in the range of 20 to 100. In some embodiments, the warp yarns may have a denier in the range of 30 to 80. Alternatively, the warp yarns may have a denier in the range of 20 to 60, 40 to 80, 60 to 100, or any other suitable range of deniers.

The weft yarns of layers 12 and 14 may be spaced at a density in the range of 6 to 48 yarns per inch as measured longitudinally of tape 10. In some embodiments, the weft yarns may be spaced at a density in the range of 9 to 18 yarns per inch as measured longitudinally of tape 10. Alternatively, the weft yarns may be spaced at a density in the range of 6 to 24 yarns per inch, 18 to 36 yarns per inch, 30 to 48 yarns per inch, or any other suitable range of densities. The weft yarns of layers 12 and 14 may have a denier in the range of 40 to 300. In some embodiments, the weft yarns may have a denier in the range of 50 to 200. Alternatively, the weft yarns may have a denier in the range of 40 to 170, 170 to 300, or any other suitable range of deniers.

Each of layers 12 and 14 may have a weight of not more than about 1.5 ounces per square yard. In some embodiments, each of layers 12 and 14 may have a weight in the range of 0.3 to 0.5 ounces per square yard. Alternatively, each of layers 12 and 14 may have a weight in the range of 0.3 to 1.0 ounces per square yard, 0.8 to 1.5 ounces per square yard, or any other suitable range of weights.

An example of an illustrative fabric that may be used for layers 12 and 14 of tape 10 is style number J477 obtained from Chima, Inc., of Reading, Pa. (“the Chima fabric”). The Chima fabric is a polyester warp-knitted weft-insertion fabric having a warp denier of about 50 and a weft denier of about 150. The Chima fabric weighs approximately 0.74 ounces per square yard, and has a tensile strength of about 22 pounds per inch. Another example of an illustrative fabric that may be used for layers 12 and 14 of tape 10 is style number 071255 obtained from Milliken & Company of Spartanburg, S.C. (“the Milliken fabric”). The Milliken fabric is a polyester warp-knitted weft-insertion fabric having a warp denier of about 40 and a weft denier of about 70. The Milliken fabric weighs approximately 0.43 ounces per square yard, and has a tensile strength of about 18 pounds per inch. Yet another example of an illustrative fabric that may be used for layers 12 and 14 of tape 10 is style number 013228400011 obtained from DeRoyal Textiles of Camden, S.C. (“the DeRoyal fabric”). The DeRoyal fabric is a cotton scrim woven fabric having a warp yarn density of about 32 yarns per inch measured transversely of the tape and a weft yarn density of about 28 yarns per inch measured longitudinally of the tape. The DeRoyal fabric weighs approximately 1.31 ounces per square yard. Still other examples of fabrics that may be used for layers 12 and 14 of tape 10 includes greige cloth and other such scrim woven fabrics known in the art.

As shown in FIGS. 1-3, tape 10 may include a nonwoven layer of material 16 positioned between layers 12 and 14. The fibers of nonwoven material 16 are intimately entangled with each other to form a coherent, breathable fibrous material. Nonwoven material 16 may be, for example, a synthetic spunbonded nonwoven material. Alternatively, nonwoven material 16 may be any other suitable type of nonwoven material, such as, for example, a spun-melted nonwoven material, a wet laid nonwoven material, a dry laid nonwoven material, a needle punched nonwoven material, or a melt blown nonwoven material. Nonwoven material 16 may be constructed of any suitable material, such as, for example, nylon, polyester, polypropylene, rayon, cellolosic, polyamide, acrylic, polyethylene, cotton, wool, any other suitable material, or a combination of such materials. Nonwoven material 16 may have a weight in the range of 0.25 to 1.0 ounces per square yard. In some embodiments, nonwoven material 16 may have a weight in the range of 0.3 to 0.5 ounces per square yard. Alternatively, nonwoven material 16 may have a weight in the range of 0.25 to 0.6 ounces per square yard, 0.4 to 0.7 ounces per square yard, 0.6 to 1.0 ounces per square yard, or any other suitable range. An example of an illustrative fabric that may be used for nonwoven layer 16 of tape 10 is a spunbonded polypropylene nonwoven material obtained from First Quality Nonwovens, Inc. of Great Neck, N.Y.

As shown in FIGS. 1-3, tape 10 may include a binder 18 to bond layers 12, 14, and 16 together. In some embodiments of the present invention, binder 18 may be applied to layers 12, 14, and 16 such that the binder substantially impregnates each of the three layers. For example, layers 12, 14, and 16 may be immersed into binder 18 to impregnate the three layers. Alternatively, binder 18 may be applied to the outer surfaces of the middle layer of tape 10, which in the embodiment shown in FIGS. 1-3 is nonwoven layer 16. Layers 12 and 14 may then be laminated thereto by placing layers 12 and 14 onto the respective outer surfaces of the nonwoven layer.

In applications in which a cohesive tape (i.e., the tape will stick only to itself) is desired, binder 18 may be a cohesive agent. Alternatively, binder 18 may be an adhesive agent used solely to laminate layers 12, 14, and 16 together. In yet another alternative embodiment, separate binding and cohesive agents may be used in connection with tape 10 to bond the layers of the tape together and create a cohesive product, respectively. In such embodiments in which separate binding and cohesive agents are used, the cohesive agent may be applied to layers 12, 14, and 16 such that the cohesive agent substantially impregnates each of the three layers. For example, layers 12, 14, and 16 may be immersed into the cohesive agent to impregnate the three layers. Alternatively, the cohesive agent may be applied to the outer layers of tape 10, which in the embodiment shown in FIGS. 1-3 are layers 12 and 14.

In embodiments in which binder 18 is a cohesive agent, the binder may be a latex-based cohesive agent such as, for example, a natural rubber latex-based cohesive agent. A natural rubber latex-based cohesive agent may contain a mixture of natural rubber modified with tackifying resins and pigments. Alternatively, binder 18 may be a synthetic water-based cohesive agent (e.g., in applications in which a latex-free product is desired). Examples of synthetic water-based cohesive agents are described, for example, in commonly-assigned Taylor U.S. Pat. No. 6,156,424 (“the Taylor patent”), which is hereby incorporated by reference herein in its entirety. As described in the Taylor patent, a synthetic water-based cohesive agent may include an elastomer having an inherently crystalline structure and at least one tackifying agent in an amount effective to disrupt the crystalline structure of the elastomer in a partial polycrystalline state such that the elastomer possesses a cohesive property. Such an elastomer may include, for example, polychloroprene, polyester polyurethane, or polycaprolactone polyurethane. (It should be noted that both the latex- and non-latex-based cohesive agents described hereinabove are applicable in embodiments of the present invention in which the cohesive agent is separate from binder 18.)

As described hereinabove, layers 12 and 14 may provide tape 10 with the desired longitudinal tensile strength for certain applications (e.g., wrapping an athlete's muscles). The longitudinal tensile strength of tape 10 may be based primarily on the tensile strengths of layers 12 and 14. In general, the tensile strength of nonwoven layer 16 is substantially negligible in calculating the overall tensile strength of tape 10. This is due in part to the elasticity of nonwoven layer 16 which, when positioned between layers 12 and 14, provides an insignificant amount of resistance to tape 10. In contrast, layers 12 and 14 are substantially non-elastic in at least the longitudinal direction. For example, layers 12 and 14 may undergo an insignificant change in length in the longitudinal direction when a tensile force is applied (e.g., less than 0.5% change in length). Thus, for simplicity, the tensile strength of nonwoven layer 16 will be disregarded for the calculations included herein. In other words, the longitudinal tensile strength of tape 10 will be calculated as the sum of the respective tensile strengths of layers 12 and 14. For an overall tensile strength for tape 10 of about 40 pounds per inch in the longitudinal direction, for example, the desired tensile strength may be obtained by choosing a material or materials for layers 12 and 14 that have a cumulative tensile strength of 40 pounds per inch (e.g., 20 pounds per inch and 20 pounds per inch, 22 pounds per inch and 18 pounds per inch, 15 pounds per inch and 25 pounds per inch, etc.).

The longitudinal tensile strength of tape 10 as an assembly of layers 12, 14, and 16 may be in the range of 20 to 80 pounds per inch in the longitudinal direction. In some embodiments, the tensile longitudinal strength of tape 10 may be in the range of 30 to 60 pounds per inch in the longitudinal direction. Alternatively, the longitudinal tensile strength of tape 10 may be in the range of 20 to 60 pounds per inch, 40 to 80 pounds per inch, or any other suitable range of tensile strength.

In some embodiments of the present invention, it may be desired to provide an adhesive tape 10. Accordingly, a layer of pressure-sensitive adhesive may be coated on the outer surface of one or both of layers 12 and 14.

In some embodiments of the present invention, it may be desired to provide tape 10 in a particular color or print. In one example, to dye tape 10 a particular color, dye may be incorporated into binder 18. Alternatively, in embodiments of the present invention in which binder 18 and a separate cohesive agent are used, the dye may be incorporated into either the cohesive agent or the binder. This example is merely illustrative, and colors or prints may be applied to tape 10 using any other suitable technique known to those of skill in the art.

FIGS. 1-3 illustrate an embodiment of the hand-tearable non-elastic tape of the present invention that includes three layers of material: two layers of woven material (layers 12 and 14), and one layer of nonwoven material (layer 16). Alternatively, the tape of the present invention may include two layers, as shown in FIG. 4. FIG. 4 illustrates a tape 20 that includes woven layer 22 and nonwoven layer 26, bound by binder 28. Layers 22 and 26 and binder 28 of tape 20 may possess similar properties to similarly numbered layers 12 and 16 and binder 18 of tape 10. In yet another alternative embodiment, tape 10 may include any suitable number of layers, with one of the layers being a woven material (e.g., scrim woven fabric, warp-knitted weft-insertion fabric) and another of the layers being a nonwoven material.

Described hereinbelow is an example of the hand-tearable non-elastic tape of the present invention. This is merely an example and is not intended to limit the present invention in any way.

In an illustrative example of hand-tearable non-elastic tape 10 of the present invention, layers 12 and 14 are warp-knitted weft-insertion materials that each include polyester non-elastic warp yarns spaced at a density of about 18 yarns per inch measured transversely of the tape. Layers 12 and 14 each include texturized polyester filament weft yarns spaced at a density of about 12 yarns per inch measured longitudinally of the tape. A spunbonded nonwoven material 16 is positioned between layers 12 and 14. A natural rubber latex-based cohesive agent bonds layers 12, 14, and 16 together. Layer 12 has a weight of about 0.7 ounces per square yard. The warp yarns of layer 12 have a denier of about 50, and the weft yarns of layer 12 have a denier of about 150. Layer 14 has a weight of about 0.4 ounces per square yard. The warp yarns of layer 14 have a denier of about 40, and the weft yarns of layer 14 have a denier of about 70. Layer 12 has a tensile strength of about 22 pounds per inch in the longitudinal direction, and layer 14 has a tensile strength of about 18 pounds per inch in the longitudinal direction. This combination of tensile strengths yields an overall tensile strength for tape 10 of about 40 pounds per inch in the longitudinal direction.

As used herein, the term “about” means approximately, in the region of, roughly, or around. When the term “about” is used in conjunction with a numerical range, it modifies that range by extending the boundaries above and below the numerical values set forth, e.g., to modify a numerical value by plus or minus 10% of the stated value, rounded to the nearest whole number.

It will be understood that the foregoing is only illustrative of the principles of the present invention, and that still other modifications can be made by those skilled in the art without departing from the scope and spirit of the invention. For example, the various materials mentioned herein are only examples, and other materials possessing similar properties can be used, if desired.

What is claimed is:

1. A laminated non-elastic tape, comprising:
two layers of material, each layer comprising warp yarns extending longitudinally of the tape and weft yarns extending transversely of the tape, wherein the warp yarns are non-elastic; and
a layer of nonwoven material positioned between the two layers of material.

2. The laminated tape of claim 1, wherein at least one of the two layers of material comprising warp yarns and weft yarns is a warp-knitted weft-insertion fabric.

3. The laminated tape of claim 2, wherein both of the two layers of material comprising warp yarns and weft yarns are warp-knitted weft-insertion fabrics.

4. The laminated tape of claim 2, wherein the warp yarns of the at least one of the two layers of material comprise a plurality of longitudinally-spaced knitted loops and the weft yarns extend transversely of the tape through the loops of the warp yarns.

5. The laminated tape of claim 1, wherein at least one of the two layers of material comprising warp yarns and weft yarns is a scrim woven fabric.

6. The laminated tape of claim 5, wherein both of the two layers of material comprising warp yarns and weft yarns are scrim woven fabrics.

7. The laminated tape of claim 5, wherein adjacent warp yarns of the at least one of the two layers of material extend longitudinally of the tape on opposing sides of a plane defined by the weft yarns.

8. The laminated tape of claim 1, wherein one of the two layers of material comprising warp yarns and weft yarns is a warp-knitted weft-insertion fabric and the other of the two layers of material comprising warp yarns and weft yarns is a scrim woven fabric.

9. The laminated tape of claim 1, wherein one or both of the warp yarns and weft yarns comprise polyolefin yarns.

10. The laminated tape of claim 1, wherein one or both of the warp yarns and weft yarns comprise polyester yarns.

11. The laminated tape of claim 1, wherein one or both of the warp yarns and weft yarns comprise polycotton yarns.

12. The laminated tape of claim 1, wherein one or both of the warp yarns and weft yarns comprise cotton yarns.

13. The laminated tape of claim 1, wherein at least one of the two layers of material comprising warp yarns and weft yarns comprises weft yarns having texturized filament yarns.

14. The laminated tape of claim 1, wherein at least one of the two layers of material comprising warp yarns and weft yarns comprises warp yarns spaced at a density in the range of 12 to 24 yarns per inch measured transversely of the tape.

15. The laminated tape of claim 14, wherein at least one of the two layers of material comprising warp yarns and weft yarns comprises warp yarns spaced at a density of about 18 yarns per inch measured transversely of the tape.

16. The laminated tape of claim 1, wherein at least one of the two layers of material comprising warp yarns and weft yarns comprises warp yarns having a denier in the range of 30 to 80.

17. The laminated tape of claim 16, wherein at least one of the two layers of material comprising warp yarns and weft yarns comprises warp yarns having a denier of about 50.

18. The laminated tape of claim 16, wherein at least one of the two layers of material comprising warp yarns and weft yarns comprises warp yarns having a denier of about 40.

19. The laminated tape of claim 1, wherein at least one of the two layers of material comprising warp yarns and weft yarns comprises weft yarns that are spaced at a density in the range of 9 to 18 yarns per inch measured longitudinally of the tape.

20. The laminated tape of claim 19, wherein at least one of the two layers of material comprising warp yarns and weft yarns comprises weft yarns that are spaced at a density of about 12 yarns per inch measured longitudinally of the tape.

21. The laminated tape of claim 1, wherein at least one of the two layers of material comprising warp yarns and weft yarns comprises weft yarns that have a denier in the range of 50 to 200.

22. The laminated tape of claim 21, wherein at least one of the two layers of material comprising warp yarns and weft yarns comprises weft yarns that have a denier of about 150.

23. The laminated tape of claim 21, wherein at least one of the two layers of material comprising warp yarns and weft yarns comprises weft yarns that have a denier of about 70.

24. The laminated tape of claim 1, wherein each layer of the two layers of material comprising warp yarns and weft yarns has a weight of not more than about 1.5 ounces per square yard.

25. The laminated tape of claim 24, wherein each layer of the two layers of material comprising warp yarns and weft yarns has a weight in the range of 0.3 to 0.8 ounces per square yard.

26. The laminated tape of claim 1, wherein:
the warp yarns of at least one of the two layers of material comprise a plurality of longitudinally-spaced knitted loops;
the weft yarns of the at least one of the two layers of material extend transversely of the tape through the loops of the warp yarns; and
the warp yarns of the at least one of the two layers of material are knitted such that the loops formed by the warp yarns include three yarn portions.

27. The laminated tape of claim 1, further comprising a binder bonding the layers together.

28. The laminated tape of claim 27, wherein the binder is a cohesive or adhesive agent.

29. The laminated tape of claim 28, wherein the binder is a cohesive agent.

30. The laminated tape of claim 29, wherein the binder is a latex-based cohesive agent.

31. The laminated tape of claim 30, wherein the binder is a natural rubber latex-based cohesive agent.

32. The laminated tape of claim 29, wherein the binder is a synthetic water-based cohesive agent.

33. The laminated tape of claim 32, wherein the synthetic water-based cohesive agent comprises:
an elastomer having an inherently crystalline structure and selected from the group consisting of polychloroprene, polyester polyurethane, and polycaprolactone polyurethane; and
at least one tackifying agent in an amount effective to disrupt the crystalline structure of the elastomer in a partial polycrystalline state such that the elastomer possesses a cohesive property.

34. The laminated tape of claim 27, wherein the binder impregnates each of the layers.

35. The laminated tape of claim 1, further comprising a cohesive agent.

36. The laminated tape of claim 35, wherein the cohesive agent is a latex-based cohesive agent.

37. The laminated tape of claim 35, wherein the cohesive agent is a synthetic water-based cohesive agent.

38. The laminated tape of claim 1, wherein the nonwoven material is a synthetic spunbonded nonwoven material.

39. The laminated tape of claim 1, wherein the nonwoven material has a weight of no more than about 1.0 ounce per square yard.

40. The laminated tape of claim 39, wherein the nonwoven material has a weight in the range of 0.3 to 0.5 ounces per square yard.

41. The laminated tape of claim 1, wherein the nonwoven material is a synthetic spunbonded nonwoven material selected from the group consisting of nylon, polyester, polypropylene, and rayon and has a weight of not more than about 0.3 ounces per square yard.

42. The laminated tape of claim 1, wherein the laminated layers of material yield a longitudinal tensile strength in the range of 30 to 60 pounds per inch.

43. The laminated tape of claim 42, wherein the laminated layers of material yield a longitudinal tensile strength of about 40 pounds per inch.

44. The laminated tape of claim 43, wherein the two layers of material comprising warp yarns and weft yarns each have a tensile strength of about 20 pounds per inch.

45. The laminated tape of claim 43, wherein one of the two layers of material comprising warp yarns and weft yarns has a tensile strength of about 18 pounds per inch and the other of the two layers of material comprising warp yarns and weft yarns has a tensile strength of about 22 pounds per inch.

46. The laminated tape of claim 1, wherein the two layers of material comprising warp yarns and weft yarns facilitate transverse and longitudinal hand tearing of the tape.

47. The laminated tape of claim 1, further comprising a pressure-sensitive adhesive coated on the outer side of one of the two layers of material comprising warp yarns and weft yarns.

48. A laminated non-elastic tape, comprising:
a first layer of warp-knitted weft-insertion material comprising warp yarns having a plurality of longitudinally-spaced knitted loops extending longitudinally of the tape and weft yarns extending transversely through the plurality of longitudinally-spaced knitted loops, wherein the warp yarns are non-elastic; and
a single second layer of nonwoven material positioned adjacent to the first layer.

49. The laminated tape of claim 48, further comprising:
a third layer of material comprising warp yarns extending longitudinally of the tape and weft yarns extending transversely of the tape, wherein the warp yarns are non-elastic.

50. The laminated tape of claim 49, wherein the second layer of material is positioned between the first and third layers of material.

51. The laminated tape of claim 49, wherein the first layer of material is positioned between the second and third layers of material.

52. A laminated non-elastic tape, comprising:
first and second layers of warp-knitted weft-insertion material to facilitate transverse and longitudinal hand tearing of the tape, each layer comprising polyester non-elastic warp yarns extending longitudinally of the tape and texturized polyester filament weft yarns extending transversely of the tape, the warp yarns comprising a plurality of longitudinally-spaced knitted loops through which the weft yarns extend,
a layer of polypropylene spunbonded nonwoven material positioned between the first and second layers of warp-knitted weft-insertion material, and
a binder that impregnates each of the layers to bond the layers together.

53. The laminated non-elastic tape of claim 52, wherein the warp yarns of at least one of the first and second layers of warp-knitted weft insertion material are spaced at a density of about 18 yarns per inch measured transversely of the tape.

54. The laminated non-elastic tape of claim 52, wherein the weft yarns of at least one of the first and second layers of warp-knitted weft insertion material are spaced at a density of about 12 yarns per inch measured transversely of the tape.

55. The laminated non-elastic tape of claim 52, wherein at least one of the first and second layers of warp-knitted weft insertion material has a weight of 0.6 to 0.8 ounces per square yard.

56. The laminated non-elastic tape of claim 52, wherein at least one of the first and second layers of warp-knitted weft insertion material has warp yarns of a denier of about 50.

57. The laminated non-elastic tape of claim 52, wherein at least one of the first and second layers of warp-knitted weft insertion material has weft yarns of a denier of about 150.

58. The laminated non-elastic tape of claim 52, wherein at least one of the first and second layers of warp-knitted weft insertion material has warp yarns of a denier of about 40.

59. The laminated non-elastic tape of claim 52, wherein at least one of the first and second layers of warp-knitted weft insertion material has weft yarns of a denier of about 70.

60. The laminated non-elastic tape of claim 52, wherein at least one of the first and second layers of warp-knitted weft insertion material has a weight of 0.3 to 0.5 ounces per square yard.

61. The laminated non-elastic tape of claim 52, wherein at least one of the first and second layers of warp-knitted weft insertion material has a weight of about 0.7 ounces per square yard.

62. The laminated non-elastic tape of claim 52, wherein the nonwoven material has a weight of about 0.4 ounces per square yard.

63. The laminated non-elastic tape of claim 52, wherein the binder is a natural rubber latex-based cohesive agent.

64. The laminated non-elastic tape of claim 52, wherein at least one of the first and second layers of warp-knitted weft insertion material has a tensile strength of about 22 pounds per inch.

65. The laminated non-elastic tape of claim 52, wherein at least one of the first and second layers of warp-knitted weft insertion material has a tensile strength of about 18 pounds per inch.

66. The laminated non-elastic tape of claim 52, wherein the overall tensile strength of the laminated non-elastic tape is about 40 pounds per inch in the longitudinal direction.
